(19) United States
(12) Patent Application Publication
(10) Pub. No.: US 2003/0006609 A1
(43) Pub. Date: Jan. 9, 2003

(54) Flexible tubing connector

(76) Inventor: Ronnie A. Yates, Fullerton, CA (US)

Correspondence Address: STETINA BRUNDA GARRED & BRUCKER, 75 ENTERPRISE, SUITE 250, ALISO VIEJO, CA, 92656, US

(21) Appl. No.: 09/900,090

(22) Filed: Jul. 6, 2001

(51) Int. Cl. F16L 35/00

(52) U.S. Cl. 285/39

(57) ABSTRACT

A connector for releasably retaining tubing includes a coupler bore with a O-ring member, a co-axial guide member, a stationary grip-ring member having a radially deployable toothed distal end for grippingly engaging the terminal portion of tubing, and a sleeve limiter disposed around the ring member for restricting ring member axial movement. A release member laterally deploys the toothed distal end and additionally operates in concert with inserted tubing to cause radial deployment of the distal end to cause surrounding receipt of the tubing. The release member then moves to a non-release position upon minimal reverse-direction tubing travel for automatic tubing retention by the toothed distal end of the stationary grip ring member. Hand movement of the release member radially deploys the toothed distal end which results in release thereof of the retained tubing and its withdrawability from the connector.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates in general to tubing connectors, and in particular to a flexible tubing connector including therewithin a grip ring member for grippingly engaging the terminal portion of a length of tubing when presented for retention and an exteriorly accessible hand-operable release member for selectively releasing the grip ring member. The connector is especially useful in tubing connections found in recreational vehicles and marine craft.

Tubing connectors are widely used in applications ranging from simple under-sink plumbing connections to sophisticated fluid delivery apparatus employed in highly technical industrial settings. Common among all applications, however, is a need for leak-proof connections that are rapidly attainable irrespective of the specific connection purpose. One typical prior art design provides relatively simple internally or externally threaded ends to a length of rigid or flexible tubing to be used for subsequent threaded engagement at each end thereof with respective conduits needing connection. While such an approach can accomplish a functional fitting which can be rendered leak-proof with proper washer placement, the time, effort, and tool requirements in achieving attachment of the length of tubing many times is prohibitive.

To overcome the disadvantages of threaded attachments, quick-action connectors have been developed which generally include a cylindrical connector body into which a conduit such as a pipe is inserted and automatically retained without the use of tools. Such a connector body usually has therewithin a gasket member for creating liquid-tight transfer, and a plurality of various parts to accomplish conduit capture. Generally, however, this plurality of parts that provides functionality is rather complicated to manufacture and/or assemble thereby being cost prohibitive. Further, such prior art devices typically require extensive interactional cooperative movements among the parts to occur smoothly and in an almost orchestrated manner for positive and reliable connections between conduits to occur. Exemplary of such prior art tubing connectors are U.S. Pat. No. 5,722,696 issued to Taneya; U.S. Pat. No. 4,804,213 issued to Guest; U.S. Pat. No. 4,867,484 issued to Guest; U.S. Pat. No. 5,024,468 issued to Burge; U.S. Pat. No. 5,096,235 issued to Oetiker; U.S. Pat. No. 5,260,179 issued to Tagagi; U.S. Pat. No. 5,161,834 issued to Norkey; U.S. Pat. No. 5,219,188 issued to Abe, et al.; U.S. Pat. No. 5,468,027 issued to Guest; U.S. Pat. No. 5,779,284 issued to Guest; U.S. Pat. No. 5,915,738 issued to Guest; U.S. Pat. No. 5,934,713 issued to Guest; and U.S. Pat. No. 6,019,396 issued to Seito, et al. Thus, while quick connections can occur when all parts are properly working in typical prior art apparatus, it is apparent that a substantial need is present for a quick connector having minimal moving parts that is readily manufacturable and less prone to malfunction and thereby results in a more dependable, economical connector product.

In view of this need, a primary object of the present invention is to provide a rapid connector especially useful for connecting flexible tubing and having a single axially movable member to facilitate disconnection of the connector from tubing.

Another object of the present invention is to provide a connector wherein the movable member is only active in achieving user-selected release of the connector from the tubing while connection to the tubing is facilitated automatically merely by axial insertion of the tubing into the connector.

These and other objects of the present invention will become apparent throughout the description thereof which now follows.

### BRIEF SUMMARY OF THE INVENTION

The present invention is a connector for releasably retaining and forming a fluid tight seal upon a terminal portion of a length of tubing preferably flexible tubing. The connector includes a coupler member having a proximal end with a proximal opening thereto and a distal end with a distal opening thereto. A circular coupler bore with an interior circumferential wall extends axially through the coupler member and has a reduced diameter annular shoulder extending from the wall within the bore and upon which a o-ring is seated for creating a liquid-tight seal with the terminal portion of the length of tubing when inserted into the connector. A generally cylindrical guide member having a circular guide bore extending therethrough is co-axially secured in place within the coupler bore immediately inside the proximal opening of the coupler member.

The connector further includes a grip-ring member having a laterally deployable toothed distal end for grippingly engaging the terminal portion of tubing, and a sleeve limiter disposed around the ring member for selectively restricting axial and radial movement of the ring member. The ring member and surrounding limiter are co-axially disposed within the guide member. An exteriorly accessible hand-operable release member is provided for selectively engaging the toothed distal end of the grip ring member. The release member additionally operates in concert with the tubing when inserted into the proximal opening such that the release member is moved axially by the tubing during insertion of the tubing into the connector thereby causing deployment of the toothed distal end of the grip ring member to allow automatic insertion of the tubing into the connector. Thereafter, the release member moves axially to a non-release position upon minimal reverse-directional travel on the tubing whereby the toothed distal end of the grip ring member moves radially inward to embed itself into the tubing and prevent any inadvertent disconnection of the tubing from the connector. When desired to disconnect the connector from the tubing, manual inward axial movement of the release member axially displaces the sleeve limiter and allows the toothed distal end of the ring member to radially move outwardly from the tubing which results in release thereof of the retained tubing and its withdrawability from the connector. Depending upon functional requirements, either only the proximal opening or both the proximal and distal openings of the coupler member are provided with tubing retention capability as above defined.

Thus, the connector of the present invention provides a tubing connector which allows a fluid-tight seal to be rapidly obtained upon the end of a tubing member merely by axial insertion of the tubing member within the connector with the O-ring being compressed between the connector and the circumference of the tubing. Such axial insertion of the tubing within the connector is facilitated without any manual manipulation of the connector or portions thereof. Subsequently, inadvertent disconnect of the tubing from the connector is prohibited by engagement of the tooth distal end of the ring member against the periphery of the tubing. However, when manual disconnect of the connector from the tubing is desired, inward axial movement of the release member allows the tooth distal end of the ring member to move radially away from the pipe periphery and thereby allows unobstructed removal of the tubing from the connector.

In the preferred embodiment, the connector of the present invention can be formed in differing pipefitting/connector configurations, such as conventional couplings, elbows, Tee's, swivels, unions and the like so as to be applicable for all tubing connection applications.

### BRIEF DESCRIPTION OF THE DRAWINGS

An illustrative and presently preferred embodiment of the invention is shown in the accompanying drawings in which:

FIG. 1 is a side elevation view of a tubing connector of the present invention;

FIG. 2 is a side elevation view partially in section of the connector of FIG. 1 disassembled;

FIG. 3 is side elevation view in section of a portion of the connector of FIG. 1 illustrating the manner in which tubing may be easily axially inserted into the connector;

FIG. 4 is a side elevation view similar to FIG. 3 illustrating the manner in which the tubing is prevented from inadvertent disconnect from the connector; and

FIG. 5 is a side elevation view in section of an L-shaped swivel tubing connector formed in conformity with the present invention.

### DETAILED DESCRIPTION OF THE PREFERRED EMBODIMENTS

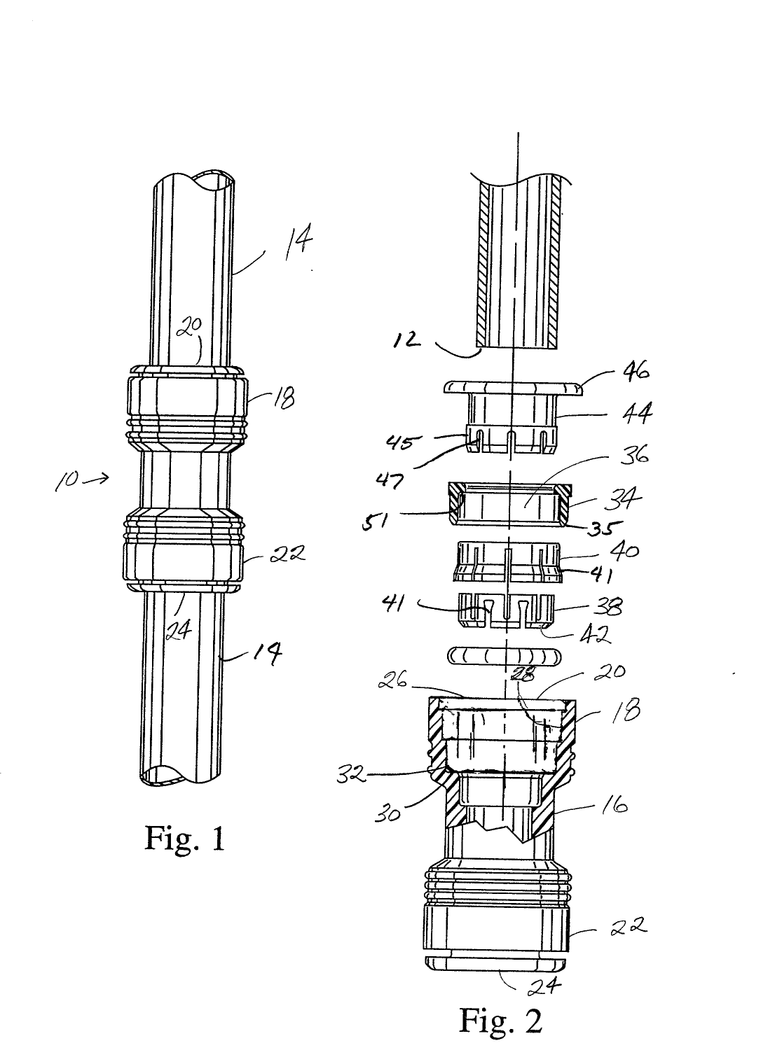

Referring to FIGS. 1-4, a coupling connector 10 is shown for releasably retaining the terminal end portions 12 of a pair of lengths of fluidic tubing 14. Although not by way of limitation, in the preferred embodiment the fluidic tubing 14 comprises lengths of flexible polymer tubing, such as high-pressure extruded cross-link polyethylene tubing. Those skilled in the art will recognize that the connector 10 is applicable to other more generally rigid pipe such as polyvinylchloride (PVC) and acetylbutylsilicate (ABS), as well as a brass connection interface with fittings. An increased diameter recess 28 is disposed adjacent the ends 20 and 22 and an annular shoulder 30 is disposed axially inward adjacent ends 20 and 22. The annular shoulder 30 seats a conventional O-ring 32 which as shown is disposed a short distance axially inward from opposite ends 20 and 22 of the cylinder coupler body 16.

A generally cylindrical guide member 34 having a circular guide bore 36 formed therethrough is axially retained within the enlarged diameter section 28. Both the body 16 and guide member 34 are preferably fabricated of identical polymeric material so as to be capable of being sonically welded together to form a rigid assembly. In the preferred embodiment, such polymer material is a commercially available polysulfone, however those skilled in the art will recognize that different polymeric materials are contemplated herein.

Co-axially disposed within the guide bore 36 of the guide member 34 are a stationery grip ring member 38 and sleeve limiter 40. In the preferred embodiment, the grip ring member 38 is preferably formed of a stainless steel material having plural axially extending slots 41 preferably equally spaced along its perimeter which define plural tooth like members 42 having relatively sharp chisel point distal ends. The tooth like members 42 are designed to be capable of limited radial flexion as will be described in further detail to allow quick axial insertion of the tubing length 14 into the connector while prohibiting inadvertent tubing disconnect from the connector.

The sleeve limiter 40 is preferably formed of a polymer material different from the polymer material utilized on the body 16 and guide member 34 such that the limiter 40 is not sonically welded to the body 16 and/or guide member 34 during the manufacturing process. As shown in FIGS. 2, 3 and 4, the distal end 35 of the guide member 34 is formed having an annular bevel 35 which cooperates with a complementary formed annular bevel 41 formed in the sleeve limiter 40.

The assembly of the various members to form the coupler 10 of the present invention is facilitated by first inserting the O-ring 32 to reside within the interior of the body 16 and be seated against the annular shoulder 30. Subsequently, the ring member 38 may be inserted to reside within the interior diameter of the sleeve limiter 40 with both members being axially disposed within the interior diameter of the guide member 34. Subsequently, the grip ring member 38, limiter member 40 and guide member 34 may be inserted into the proximal end 20 of the body 16. The guide member 34 may then be affixed or secured to the enlarged diameter 28 of the body 16 preferably via sonic welding. In this regard, in view of the guide member 34 and body 16 being formed of the same polymer material while the limiter 40 being formed of a differing polymer material, the sonic welding process securely fastens the guide member 34 to the body 16 while not affixing the limiter 40 to the guide member 34. However, those skilled in the art will recognize that differing assembly techniques are contemplated, such as spin-welding and/or adhesive bonding.

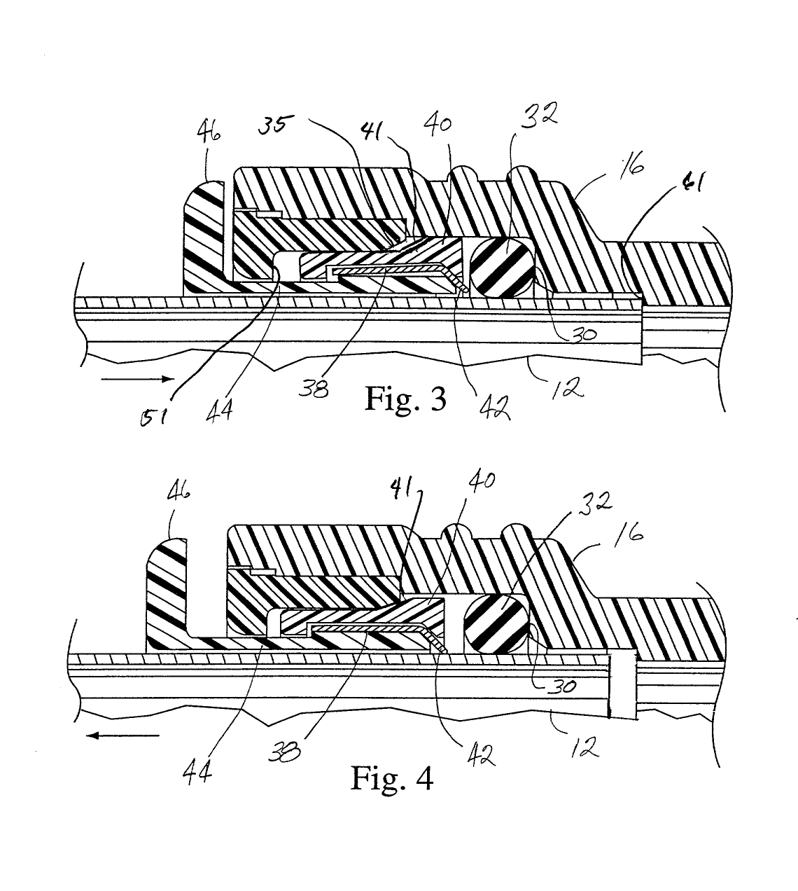

Subsequently, an annular release member or sleeve 44 may be inserted axially through the limiter 34. As best shown, the release member 44 includes an enlarged flange portion 46 adjacent one end, a reduced diameter central portion and an end portion 45 having a diameter greater than the central portion 44 but less than the internal diameter of the gripper ring member 38. The diameter portion 45 additionally is provided with plural slots 47 such that the diameter portion 45 is free to moderately radially flex inwardly and/or outwardly. The release member 44 may then be axially pushed through the interior of the sleeve limiter 40 and ring member 38 such that the diameter portion 45 resides between opposite ends of the sleeve limiter 40 as depicted in FIGS. 3 and 4. As will be recognized, by this assembly the release member 44 may be axially reciprocated relative the body 16 for a short distance with forward axial movement being stopped by contact with the O-ring 32, with rearward axial movement being stopped by contact with the annular wall 51 formed on the guide member 34. Although for purposes of description, the assembly of the limiter 40 ring member 38 guide member 34 and release member 44 were described in relation to only the proximal end of the body 16, it will be recognized that the same assembly is contemplated on the distal end 22 of the assembly 16 such that opposite pipe lengths 14 may be inserted into the coupling connector 10 of the present invention.

With the structure defined, the operation of the coupler connection 10 of the present invention may be described with specific reference to FIGS. 3 and 4. As best shown in FIG. 3, when it is desired to form a fluid-tight connection between the tubing end 14 and the coupler 10, a user merely co-axially aligns the tubing end 12 with the axial bore formed in the release member 46. Subsequently, the tubing length 14 may be inserted axially through the interior of the coupler until such time as the distal end of the tubing abuts the annular shoulder 61 formed on the body 16. During axial travel of the tubing end 12, the tubing compresses the O-ring 32 causing a fluid-tight connection to be obtained between the periphery of the tubing end 12 and O-ring 32. During such axial insertion of the tubing, the release member 46 is free to travel axially inward a short distance whereby the limiter member 40 is moved a slight distance axially inward such that its beveled annular diameter 41 is slightly spaced from the annular beveled diameter 35 formed on the guide member. In view of the separation of the beveled annular surfaces 41 and 35, the distal end of the limiter member 40 is free to move radially outward away from the tubing such that the flexible teeth 42 of the gripper ring member 38 are additionally free to move radially outward off the periphery of the tubing end 12 as shown in FIG. 3. Thereafter, a slight rearward movement of tubing 12 in a direction opposite to the arrow shown in FIG. 3 causes the release member 40 to move a slight distance axially away from the body 16 to a position shown in FIG. 4. During such slight axial rearward movement, the beveled annual surface 41 on the limiter member 38 contacts the annular beveled surface 35 on the guide member whereby the limiter member is axially compressed causing the teeth members 42 formed on the ring member 38 to tightly contact the periphery of the tubing end 12 as depicted in FIG. 4. The contact of the tooth portions 42 of the limiting ring member 38 prevent any further axial movement of the tubing end 12 relative the coupling body 16. As such, insertion of the tubing length 12 into the connector can be easily facilitated merely by axial movement of the tubing relative the coupler and without the need for any manual manipulation of any component of the coupler assembly. Additionally, once a slight rearward movement of the coupler relative the tubing end 12 is facilitated, i.e., from the position shown in FIG. 3 to that shown in FIG. 4, any inadvertent disconnect of the tubing end 12 from the coupler is prohibited by interaction of the tooth portions 42 of the gripper ring 38 contacting the periphery of the tubing end 12. As such, the gripper ring 38 forms a unidirectional gripping mechanism to allow easy insertion yet prevent inadvertent disconnect of the tubing from the connector.

When it is desired to selectively disengage and/or release the coupler 10 from the tubing end 12, a user merely manually axially reciprocates the release member from its position shown in FIG. 4 back to its position shown in FIG. 3 wherein the limiter member 40 moves a short distance axially inward such that a slight gap exists between the annular surfaces 41 and 35. The release member thereby radially extends the tooth portions 42 of the gripper ring 38 such that the tubing length 12 is then free to be axially separated from the connector 10. As such, the connector 10 of the present invention facilitates rapid connection and easy selected disconnection of the coupler from a tubing length.

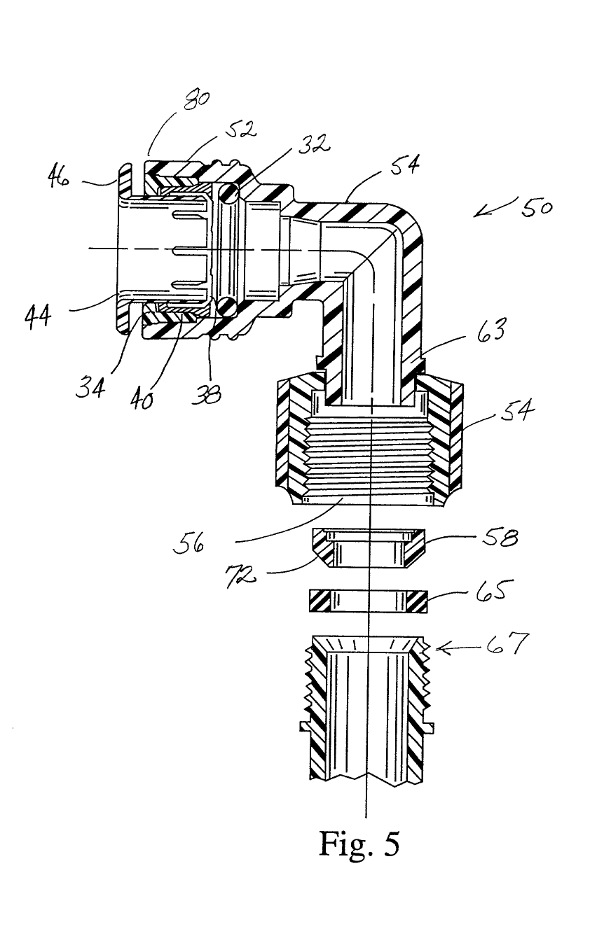

Referring more particularly to FIG. 5, an additional embodiment of the present invention is disclosed which comprises a swivel elbow fluidic connector. As will be recognized, in this embodiment, one end 80 is formed and fabricated in an identical manner to that described in relation to the coupler connector 10 described in FIGS. 1 through 4. However, the lower opposite end of the connector 50 is formed to have a swivel connection which accepts a standard threaded pipe end (not shown) or, preferably, a straight-thread (Qest) pipe 67 as illustrated in FIG. 5. As there shown, a retainer ring 58, which, upon connector assembly, is sonically welded to the end 63 of the connector 50, precedes entry into the threaded collar 56, and is followed by a compressible flat washer 65 such as a rubber washer to fit over the beveled angle 72 of the ring 58. A liquid-tight connection is then completed by inserting the pipe 67 into the collar 56 and tightening the pipe 67 such that the washer 65 becomes an interface between the ring 58 and adjacent end of the pipe 67 along the plane of the beveled angle 72. As such, a conventional threaded fastener not shown may be threadably inserted into the threaded aperture 56 and which upon axial threaded insertion, compresses the washer 65 between the threaded tubing connection and the retainer ring 58. As such, a fluidic seal is provided between the connector 50 and threaded tubing end. An additional tubing end may then be inserted into the opposite end of the connector in a manner previously described to form a fluid-tight seal. As earlier mentioned, although for purposes of illustration, only a straight coupler and swivel connector have been depicted. However, those skilled in the art will recognize that the inventive concepts of the present invention are equally applicable to other conventional tubing fittings such as elbows, T's, unions and the like. The connector 10 is formed having a generally cylindrical body 16 having a proximal end 18 with a proximal opening 20 thereto, a distal end 22 with a distal opening 24 thereto, and a circular coupler bore 26 extending axially between the ends 20 and 22.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A connector for releasably retaining a terminal portion of a length of tubing, the connector comprising:
a coupler member having a proximal end with a proximal opening thereto and a distal end with a distal opening thereto, said coupler member having a circular bore therethrough with an interior circumferential wall and a proximal annular shoulder within said bore extending from the wall;
an O-ring member disposed on the annular shoulder for creating a liquid-tight seal with the terminal portion of the length of tubing when said length is presented;
a generally cylindrical guide member having a circular guide bore therethrough, said guide member axially secured in place within the coupler bore immediately inside the proximal opening of the coupler member;
a grip ring member having a radially deployable toothed distal end for grippingly engaging the terminal portion of the length of tubing when presented into the proximal opening for retention;
a sleeve limiter disposed around the ring member for restricting radial movement of the grip ring member, said ring member and surrounding limiter disposed concentrically within the guide member; and
an exteriorly accessible hand-operable release member for axially deploying the toothed distal end of the grip ring member, said release member additionally operable in concert with the terminal portion of the length of tubing when entered into the proximal opening for retention such that the release member is moved by the length of tubing during tubing insertion to cause radial deployment of the toothed distal end of the grip ring member and surrounding receipt of said terminal portion, and with said release member thereafter moving to a non-release position upon reverse direction of travel of said length of tubing for automatic retention of said terminal portion.

2. A connector as claimed in claim 1 wherein the release member comprises an axially-movable proximally-flanged sleeve disposed co-axially within the grip ring, whereby distal movement of the release member laterally deploys the toothed distal end of the grip ring member.

3. A connector as claimed in claim 1 wherein the guide member is secured to the interior circumferential wall of the coupler bore by sonic weld.

4. A connector as claimed in claim 1 wherein the grip ring member is fabricated of stainless steel.

5. A connector as claimed in claim 1 wherein said guide member and coupler member are formed of a polymer material.

6. A connector as claimed in claim 5 wherein said coupler member and guide member are formed of a first polymer material and said sleeve limiter is formed of a different polymer material.

7. A connector as claimed in claim 1 wherein said guide member and said sleeve limiter are both formed having beveled annular surfaces to provide a radially inward camming force against said grip ring member.
